(19) United States
(12) Patent Application Publication
(10) Pub. No.: US 2025/0280792 A1
(43) Pub. Date: Sep. 11, 2025

(54) Small Dog Snow Suit Device

(71) Applicant: Shauna Swanson, Pierre, SD (US)

(72) Inventor: Shauna Swanson, Pierre, SD (US)

(21) Appl. No.: 18/754,731

(22) Filed: Jun. 26, 2024

Related U.S. Application Data
(60) Provisional application No. 63/563,603, filed on Mar. 11, 2024.

(51) Int. Cl. A01K 13/00

(52) U.S. Cl. CPC A01K 13/007

(57) ABSTRACT

A pet clothing device is disclosed that provides an improved pet clothing garment that protects small dogs against wetness, coldness, and heat due to different types of weather. The pet clothing device comprises a body component that is comprised of four leg components that are configured in a tubular shape that connect through a securing means. The body component would be a neoprene-type material to safeguard against wetness and maintain heat. Thus, the pet clothing device functions as a suitable way of protecting your pet on walks in any kind of weather.

### CROSS-REFERENCE TO RELATED APPLICATION

The present application claims priority to, and the benefit of, U.S. Provisional Application No. 63/563,603, which was filed on Mar. 11, 2024, and is incorporated herein by reference in its entirety.

### FIELD OF THE INVENTION

The present invention relates generally to the field of pet clothing devices. More specifically, the present invention relates to an improved pet clothing garment that protects small dogs and other pets against wetness, cold, and heat due to different types of weather. Accordingly, the present disclosure makes specific reference thereto. Nonetheless, it is to be appreciated that aspects of the present invention are also equally applicable to other like applications, devices, and methods of manufacture.

### BACKGROUND

By way of background, this invention relates to improvements in pet clothing devices. Generally, dogs can get uncomfortable walking outdoors in rough, hot, or cold terrains as it is rough on the pads of their paws. Different outfits can be placed on the dog to shield the paws; however, the outfit may impact how the dog walks and be uncomfortable all in all. Accordingly, people may be looking for a comfortable outfit for dogs to allow their paws to be safe.

Further, the use of dog outfits to protect the dog's paws on outdoor terrain has been seen in the prior art. However, it would be desirable to include a more comfortable outfit so that the dog walks comfortably and prefers the outfit more. For example, it would be desirable to provide a collar attachment to keep the outfit on the dog, as well as soft and quick-drying materials to allow the dog the most comfort. The outfit should be dry, soft, comfortable, and allow the dog free-range of movement when walking. This outfit for dogs should be able to be used in all climates and on all outdoor terrains. Accordingly, placing dogs in conventional dog outfits is uncomfortable to the dogs and makes it hard for them to go on walks.

Accordingly, there is a demand for an improved pet clothing device that can protect small dogs and other pets with outdoor terrain and climates during walks. More particularly, there is a demand for a comfortable pet outfit or pet clothing device that is especially adapted for hot, cold, or uncomfortable walking terrains.

Therefore, there exists a long-felt need in the art for a pet clothing device that provides users with an improved pet clothing garment that protects small dogs against wetness, coldness, and heat due to different types of weather. There is also a long-felt need in the art for a pet clothing device that accommodates several different weather seasons to keep a dog comfortable while he or she walks around outdoors. Further, there is a long-felt need in the art for a pet clothing device that features a collar attachment to secure the suit and enable it to be hung up when not in use. Moreover, there is a long-felt need in the art for a device that utilizes soft, quick-drying, and comfortable materials to ensure the device remains dry while being worn. Further, there is a long-felt need in the art for a pet clothing device that offers a way for pet owners to better take care of their pets while taking them on walks. Finally, there is a long-felt need in the art for a pet clothing device that can be used for other small, four-legged pets as well.

The subject matter disclosed and claimed herein, in one embodiment thereof, comprises a pet clothing device. The device is a dog snowsuit comprised of overalls with boots attached. The pet clothing device comprises a body component that is configured in four booties that are each positioned over a pet's leg and then connected together on the back of the dog. The body component would be comprised of a material such as neoprene to safeguard against wetness and maintain heat. The body component also comprises hook and loop fasteners that allow the body component to be secured together and to stay on the dog's feet. Thus, the pet clothing device functions as a suitable way of protecting small pets against excessive heat, coldness, or inclement weather while outdoors. The device can also be used for other small, four-legged pets, as well.

In this manner, the pet clothing device of the present invention accomplishes all of the foregoing objectives and provides users with a device that provides an improved pet clothing garment that protects small dogs against outdoor terrains and climates. The device is configured into four booties made of comfortable, padded material that easily protects the legs, paws, and other feet of small pets. The device can be manufactured of a quick-drying, elastomeric material.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a pet clothing device. The device is an improved pet clothing garment that protects small dogs against wetness, coldness, and heat due to different types of weather. The pet clothing device comprises a body component that is comprised of four leg components that are configured in a tubular shape that connect through a securing means. The body component would be a neoprene-type material to safeguard against wetness and maintain heat. Thus, the pet clothing device functions as a suitable way of protecting your pet on walks in all kinds of weather.

In one embodiment, the pet clothing device comprises a body component which is comprised of four leg components, and a securing means. The body component is four booties for each of the dog's legs that are connected on the back of the dog by the securing means. Thus, the booties allow for protection of the dog's paws from the harsh outdoor ground and the securing means allows the booties to stay on the dog.

In one embodiment, the pet clothing device comprises a body component which is comprised of a leg component which is a generally tubular shape having a closed end and an open end so that the closed end surrounds the dog's paw. The body component is comprised of four of these tubular leg components for each of the dog's paws. These four leg components are long enough to cover the majority of the dog's leg and wrap around the dog's back.

In one embodiment, small pieces of material from each part of the body component extend from the leg components. These pieces of material contain the securing means which are hook and loop fasteners but could be any other kind of securing means known in the art. The securing means attaches together on the back of the dog to attach all four leg components together. The leg components are attached to other leg components. Specifically, the leg components attach to both the leg component directly horizontal and directly vertical from it.

In one embodiment, the body component is comprised of an elastic, quick-drying material such as neoprene. Thus, the body component has extra padding and/or tread on the closed end of the leg components to ensure comfort while walking outdoors.

In one embodiment, the body component also attaches to the dog's collar. This attachment is done through the same securing means as stated previously. This collar attachment allows for extra security to ensure the garment stays on the dog, as well as a way to hang the outfit to dry after the dog has worn it.

In one embodiment, the collar attachment also contains an extra warmth component such as a cape, hat, or hood. This extra warmth attachment would connect to the collar attachment with hook and loop fasteners as well. This extra warmth attachment would protect the dog from harsh weather.

In use, the pet clothing device is assembled by first placing the dog's legs into each of the leg components that comprise the body component. The leg components are then wrapped around the dog's back and connected to each other through hook and loop fasteners. The entire body component is then connected to the collar of the dog with hook and loop fasteners as well. If the device contains the extra warmth attachment, this is also attached to the collar via the same hook and loop fasteners as is stated previously.

In one embodiment, the pet clothing device can be utilized with any suitable small, four-legged pet which would fit in different sizes of the body component. This can include, but is not limited to cats, guinea pigs, ferrets, hamsters, or mice, etc.

In yet another embodiment, the pet clothing device comprises a plurality of indicia.

In yet another embodiment, a method of protecting a dog while on a walk is disclosed. The method includes the steps of providing a pet clothing device comprising a body component and leg components that are tubular structures with hook and loop fasteners. The method also comprises inserting a dog's leg into each of the four leg components. Further, the method comprises securing the body component on the dog by connecting the hook and loop fasteners at the dog's back. Finally, the method comprises securing the pet clothing device to the dog by connecting hook and loop fasteners at the dog's collar.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters

refer to similar parts throughout the different views, and in which:

FIG. 1 illustrates a top perspective view of one embodiment of the pet clothing device of the present invention showing the device applied to two separate dogs in accordance with the disclosed architecture;

FIG. 2 illustrates a top perspective view of one embodiment of the pet clothing device of the present invention showing the body component without the dog in it in accordance with the disclosed architecture;

FIG. 3 illustrates a top perspective view of one embodiment of the pet clothing device of the present invention showing how the hook and loop fasteners connect with the collar in accordance with the disclosed architecture;

FIG. 4 illustrates a top perspective view of one embodiment of the pet clothing device of the present invention showing how the hook and loop fasteners connect on the back of the dog in accordance with the disclosed architecture;

FIG. 5 illustrates a side perspective view of one embodiment of the pet clothing device of the present invention in use in accordance with the disclosed architecture; and

FIG. 6 illustrates a flowchart showing the method of protecting a dog while on a walk in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a pet clothing device that provides users with an improved pet clothing garment that protects small dogs against wetness, coldness, and heat due to different types of weather. There is also a long-felt need in the art for a pet clothing device that accommodates several different weather seasons to keep a dog comfortable while he or she walks around outdoors. Further, there is a long-felt need in the art for a pet clothing device that features a collar attachment to secure the device and enable it to be hung up when not in use. Moreover, there is a long-felt need in the art for a device that utilizes soft, quick-drying, and comfortable materials to ensure the device remains dry while being worn. Further, there is a long-felt need in the art for a pet clothing device that offers a way for pet owners to better take care of their pets while taking them on walks. Finally, there is a long-felt need in the art for a pet clothing device that can be used for other small, four-legged pets as well.

The present invention, in one exemplary embodiment, is a novel pet clothing device. The pet clothing device comprises a body component that is comprised of four leg components which are each configured in a tubular shape that have a closed end by the dog's paw and an open end up by the dog's stomach. The body component would be manufactured of a quick-drying, warm material that enables dogs to walk comfortably in difficult weather and terrain. The body component also comprises hook and loop fasteners that allow the body component to be secured to the dog. Thus, each pet clothing device functions as a suitable way of protecting your dog on a walk. The present invention also includes a novel method of protecting a dog on a walk. The method includes the steps of providing a pet clothing device comprising a body component and leg components that are tubular structures with hook and loop fasteners. The method also comprises inserting a dog's leg into each of the four leg components. Further, the method comprises securing the body component on the dog by connecting the hook and loop fasteners at the dog's back. Finally, the method comprises securing the pet clothing device to the dog by connecting hook and loop fasteners at the dog's collar.

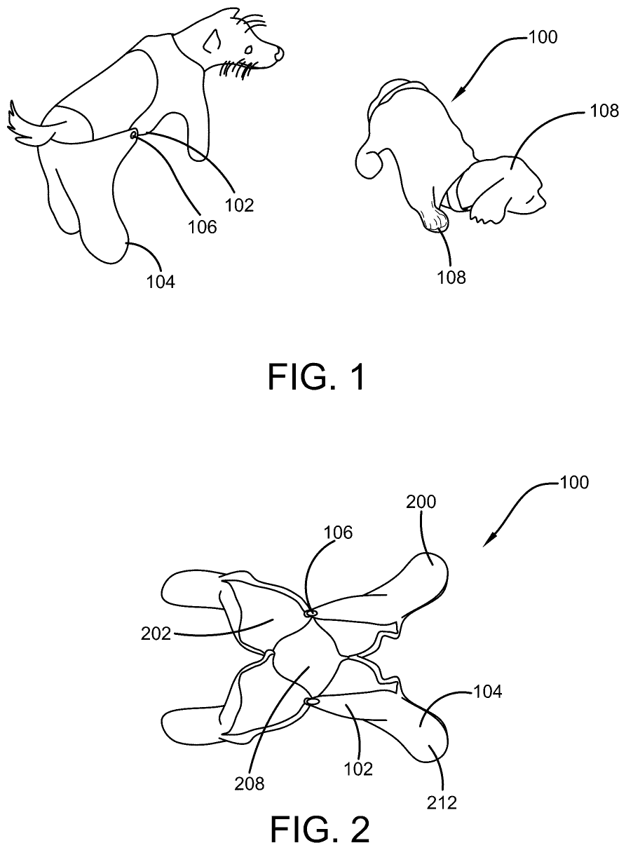

Referring initially to the drawings, FIG. 1 illustrates a top perspective view of one embodiment of the pet clothing device 100 of the present invention. In the present embodiment, the pet clothing device 100 is an improved pet clothing device 100 that provides a user with an improved pet clothing garment that protects small dogs 108 against wetness, coldness, or heat due to different types of weather. Further, the device 100 is quick-drying and warm and configured in a tubular shape that enables the dog 108 to be comfortable while on a walk. Specifically, the pet clothing device 100 comprises a body component 102 with four leg components 104 and securing means 106 for securing the device 100 to the dog 108. Thus, each pet clothing device 100 functions as a suitable way of protecting your dog 108 while on a walk, through inserting the dog 108 into the device 100.

Generally, the pet clothing device 100 comprises a body component 102, four leg components 104, and a securing means 106. The body component 102 is comprised of the four leg components 104 and the leg components 104 are all connected to one another. The securing means 106 is meant to connect the leg components 104 together while also a means of securing the body component 102 to the dog 108.

As shown in FIG. 2, the pet clothing device 100 comprises a body component 102 that is comprised of four separate leg components 104. The leg components 104 are a generally tubular shape with a closed end 200 and an open end 202. The closed end 200 contains the paw 204 of the dog 108 while the open end 202 extends up towards the dog's stomach 206.

Additionally, the leg components 104 are connected to each other by simply being sewn together or secured together through the securing means 106. The leg components 104 are connected to the leg component 104 that is directly vertical and directly horizontal to them. In this way there is an open space 208 between the four leg components 104 which is where the dog's stomach 206 will be and enables them to walk comfortably and without any rubbing or chafing.

Generally, the body component 102 is secured by attaching the leg components on the back 210 of the dog 108, but can also be configured in any other suitable shape as is known in the art, such as attached underneath or on the side, etc. The body component 102 is typically attached on the dog's back 210 as that provides the most security for the dog 108 and ensures the device 100 stays on. However, the other shapes are also suitable. The size of the body component 102 is a matter of choice, depending on the size of the dog 108 using it. Further, the body component 102 can be available in different sizes, as well, depending on the size of the dog 108.

Further, the body component 102 is made of a quick-drying, elastic material 212 such as neoprene or any other material known in the art. This material 212 could include extra padding and/or tread on the closed end 200 of the leg components 104 for walking on rough terrain. The material 212 should also be quick drying and warm to ensure maximum comfort.

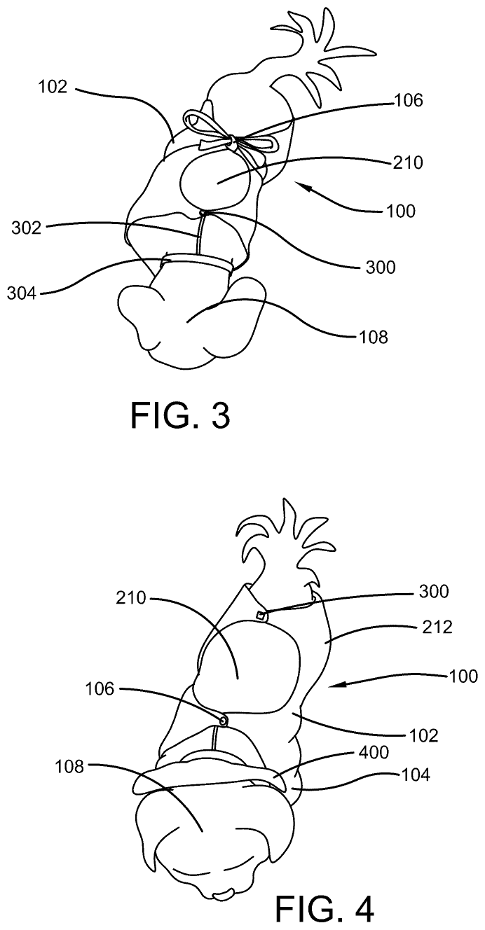

As shown in FIG. 3, the body component 102 connects on the back 210 of the dog 108. The body component 102 is connected through a securing means 106 which could be hook and loop fasteners 300 or any other material known in the art. The hook and loop fasteners 300 connect the leg components 104 across the dog's back 210 and ensure the device 100 stays on the dog 108. In one embodiment, the device 100 also includes a collar attachment 302 which connects the body component 102 to the dog's collar 304. The collar attachment 302 connects to the dog's collar 304 by the securing means 106 such as hook and loop fasteners 300. This collar attachment 302 allows for the device 100 to easily stay on the dog 108 and for the device 100 to be hung up after use.

As shown in FIG. 4, in use, the pet clothing device 100 comprises four leg components 104 attached across the back 210 of the dog 108. In one embodiment of the device 100, there is included an extra warmth component 400. This extra warmth component 400 attaches to the dog's collar 304 through the securing means 106 and ensures the dog 108 is warm. This extra warmth component 400 can be a cape, hood, hat, etc. The extra warmth component 400 should be made of the same material 212 as the rest of the body component 102, but doesn't have to be.

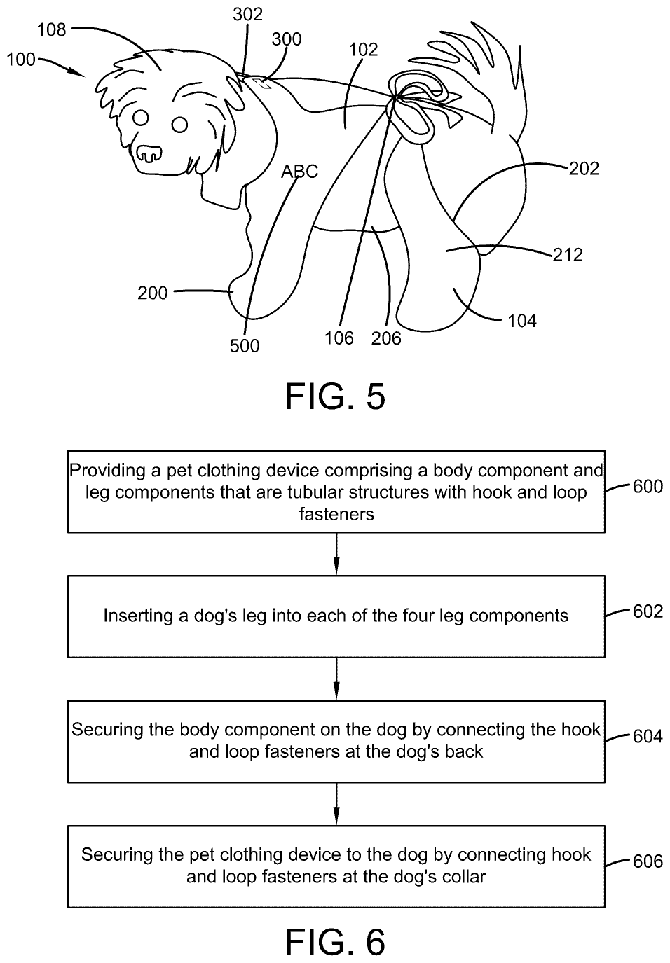

As shown in FIG. 5, the pet clothing device 100 can be utilized with any suitable weather or outdoor terrain, and even with other small, four-legged pets (not shown).

In one embodiment, the pet clothing device 100 comprises a plurality of indicia 500. The body component 102 of the device 100 may include advertising, a trademark, or other letters, designs, or characters, printed, painted, stamped, or integrated into the body component 102, or any other indicia 500 as is known in the art. Specifically, any suitable indicia 500 as is known in the art can be included, such as, but not limited to, patterns, logos, emblems, images, symbols, designs, letters, words, characters, animals, advertisements, brands, etc., that may or may not be pets, walking, or brand related.

FIG. 6 illustrates a flowchart of the method of protecting a dog on a walk. The method includes the steps of at 600, providing a pet clothing device comprising a body component and leg components that are tubular structures with hook and loop fasteners. The method also comprises at 602, inserting a dog's leg into each of the four leg components. Further, the method comprises at 604, securing the body component on the dog by connecting the hook and loop fasteners at the dog's back. Finally, the method comprises at 606, securing the pet clothing device to the dog by connecting hook and loop fasteners at the dog's collar.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “pet clothing device”, “pet device”, “clothing device”, and “device” are interchangeable and refer to the decorative container device 100 of the present invention.

Notwithstanding the foregoing, the pet clothing device 100 of the present invention can be of any suitable size and configuration as is known in the art without affecting the overall concept of the invention, provided that it accomplishes the above-stated objectives. One of ordinary skill in the art will appreciate that the pet clothing device 100 as shown in FIGS. 1-6 is for illustrative purposes only, and that many other sizes and shapes of the pet clothing device 100 are well within the scope of the present disclosure. Although the dimensions of the pet clothing device 100 are important design parameters for user convenience, the pet clothing device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A pet clothing device that provides a user with an improved pet clothing garment that protects small dogs from wetness, coldness, and heat due to different types of weather, the pet clothing device comprising:
a body component;
four leg components; and
a securing means;
wherein the body component and the four leg components are adapted to receive and secure a dog and protects the dog from inclement weather; and
further wherein the body component is secured to the dog via the securing means for security and comfort.

2. The pet clothing device of claim 1, wherein the body component comprises the four leg components which are each configured in a tubular shape.

3. The pet clothing device of claim 2, wherein each of the four leg components comprise a closed end by a dog's paw and an open end that extends up from a dog's stomach.

4. The pet clothing device of claim 3, wherein the body component has an open space between the four leg components at the dog's stomach, for maximum comfort while walking.

5. The pet clothing device of claim 4, wherein the four leg components are connected to each other across a dog's back through the securing means.

6. The pet clothing device of claim 5, wherein the body component is attached to a dog's collar through a collar attachment for security while wearing and for easier storage when off the dog.

7. The pet clothing device of claim 6, wherein the collar attachment is attached to the dog's collar through hook and loop fasteners.

8. The pet clothing device of claim 7, wherein an extra warmth component is also attached to the dog's collar to provide extra protection from the inclement weather.

9. The pet clothing device of claim 8, wherein the extra warmth component is secured to the dog's collar through hook and loop fasteners.

10. The pet clothing device of claim 9, wherein the extra warmth component is a cape, hat, or hood.

11. The pet clothing device of claim 10, wherein the pet clothing device can be utilized with other small, four-legged pets.

12. The pet clothing device of claim 11 further comprising a plurality of indicia.

13. A pet clothing device that provides a user with an improved pet clothing garment to protect small dogs against wetness, coldness, and heat due to different types of weather, the pet clothing device comprising:
a body component comprising four leg components secured for comfort on the small dog; and
a plurality of hook and loop fasteners;
wherein each of the four leg components is comprised of an elastomeric, quick-drying material in a tubular shape;
wherein the four leg components are connected through a securing means to enable a open space around a small dog's stomach;
wherein the body component is secured on the small dog by a collar attachment which is secured by a plurality of hook and loop fasteners;
wherein the collar attachment also secures an extra warmth component with a plurality of hook and loop fasteners;
wherein the extra warmth attachment is comprised of same material as the body component; and
further wherein the body component is secured across a back of the small dog for maximum security.

14. The pet clothing device of claim 13, wherein the four leg components each have a closed end which is where a small dog's paw goes and an open end that extends towards the small dog's stomach.

15. The pet clothing device of claim 13, wherein each of the four leg components are attached to a leg component that is directly vertical to it and attached to a leg component that is directly horizontal to it.

16. The pet clothing device of claim 13, wherein the pet clothing device can be utilized with any other small, four-legged pet.

17. The pet clothing device of claim 13 further comprising a plurality of indicia.

18. The pet clothing device of claim 13, wherein the extra warmth component is a cape, hat, or hood.

19. The pet clothing device of claim 13, wherein the four leg components have extra padding and/or tread on the closed end to ensure maximum comfort while walking.

20. A method of protecting a dog while on a walk, the method comprising the following steps:
providing a pet clothing device comprising a body component and four leg components that are tubular structures with hook and loop fasteners;
inserting a dog's leg into each of the four leg components;
comprises securing the body component on the dog by connecting the hook and loop fasteners at the dog's back; and
securing the pet clothing device to the dog by connecting hook and loop fasteners at the dog's collar.
